(19) United States
(12) Patent Application Publication
(10) Pub. No.: US 2021/0403083 A1
(43) Pub. Date: Dec. 30, 2021

(54) REVERSE TRAJECTORY TRACKING METHOD AND APPARATUS, ELECTRONIC DEVICE AND STORAGE MEDIUM

(71) Applicant: Beijing Baidu Netcom Science and Technology Co., LTD., BEIJING (CN)

(72) Inventor: Lianchuan ZHANG, Beijing (CN)

(21) Appl. No.: 17/174,126

(22) Filed: Feb. 11, 2021

(30) Foreign Application Priority Data
Jun. 30, 2020 (CN) 202010614812.0

(51) Int. Cl. B62D 6/00; B62D 15/02; B60W 10/20

(52) U.S. Cl. CPC B62D 6/002; B62D 15/0285; B60W 2710/207; B60W 2520/06; B60W 10/20

(57) ABSTRACT

A reverse trajectory tracking method and apparatus, an electronic device and a storage medium are disclosed by the present application, which relates to a field of autonomous driving, and in particular to a field of autonomous parking and a field of trajectory tracking. The method includes: acquiring positioning information and reference trajectory of a vehicle; determining a heading error and a lateral error of the vehicle relative to a reference trajectory based on the positioning information and reference trajectory of the vehicle; determining an expected front wheel turning angle of the vehicle based on the heading error, the lateral error and a speed of the vehicle; adjusting an actual front wheel turning angle of the vehicle according to the expected front wheel turning angle of the vehicle.

### CROSS-REFERENCE TO RELATED APPLICATION

This application claims priority to Chinese patent application No. 202010614812.0, filed on Jun. 30, 2020, which is hereby incorporated by reference in its entirety.

### TECHNICAL FIELD

The present application relates to a field of autonomous driving, and in particular, to a field of autonomous parking and a field of trajectory tracking.

### BACKGROUND

Existing trajectory tracking methods are mostly applied to a forward travel environment, and generally do not support reverse travel scenario.

### SUMMARY OF THE INVENTION

The present application provides a reverse trajectory tracking method and apparatus, an electronic device and a storage medium.

According to an aspect of the present application, a reverse trajectory tracking method is provided, which may include:

acquiring positioning information and a reference trajectory of a vehicle; determining a heading error and a lateral error of the vehicle relative to the reference trajectory, based on the positioning information and the reference trajectory of the vehicle;
determining an expected front wheel turning angle of the vehicle, based on the heading error, the lateral error and a speed of the vehicle; and adjusting an actual front wheel turning angle of the vehicle according to the expected front wheel turning angle of the vehicle.

According to another aspect of the present application, a reverse trajectory tracking apparatus is provided, which may include:

an acquisition module configured for acquiring positioning information and a reference trajectory of a vehicle;
an error determination module configured for determining a heading error and a lateral error of the vehicle relative to the reference trajectory, based on the positioning information and the reference trajectory of the vehicle;
a front wheel turning angle determination module configured for determining an expected front wheel turning angle of the vehicle based on the heading error, the lateral error and a speed of the vehicle; and
an adjustment module configured for adjusting an actual front wheel turning angle of the vehicle according to the expected front wheel turning angle of the vehicle.

According to yet another aspect of the present application, an electronic device is provided, which includes:

at least one processor; and
a memory communicatively connected to the at least one processor; wherein
the memory stores instructions executable by the at least one processor, the instructions, when executed by the at least one processor, cause the at least one processor to perform the method according to any one of the embodiments of the present application.

According to yet another aspect of the present application, a non-transitory computer readable storage medium storing computer instructions is provided, wherein the computer instructions, when executed by a computer, cause the computer to execute the method according to any one of the embodiments of the present application.

It should be understood that the contents described herein are not intended to identify key or important features of the embodiments of the present application, or limit the scope of the present application. Other features of the present application will be easier to be understood by the following description.

### BRIEF DESCRIPTION OF DRAWINGS

The accompanying drawings are provided for better understanding of the present disclosure, and rather than limiting the present application, wherein:

FIG. 1 is a flow chart of implementing a reverse trajectory tracking method according to an embodiment of the present application;

FIG. 2 is a flow chart of implementing the determination of a heading error of a vehicle relative to a reference trajectory in a reverse trajectory tracking method according to an embodiment of the present application;

FIG. 3 is a schematic diagram of relative position of a bicycle model and a reference trajectory in a reverse trajectory tracking method according to an embodiment of the present application;

FIG. 4 is a structural schematic diagram of a reverse trajectory tracking apparatus 400 according to an embodiment of the present application;

FIG. 5 is a structural schematic diagram of a reverse trajectory tracking apparatus 500 according to an embodiment of the present application; and

FIG. 6 is a block diagram of an electronic device for implementing a reverse trajectory tracking method according to an embodiment of the present application.

### DETAILED DESCRIPTION OF EMBODIMENTS

Exemplary embodiments of the present application are described below with reference to the accompanying drawings, including various details of the embodiments of the present application to facilitate the understanding, and which should be considered as merely exemplary. Thus, it should be realized by those of ordinary skill in the art that various changes and modifications can be made to the embodiments described herein without departing from the scope and spirit of the present application. Also, for the sake of clarity and conciseness, the contents of well-known functions and structures are omitted in the following description.

As described above, existing trajectory tracking methods are mostly applied to a forward travel environment, and generally do not support reverse travel scenario. Current reverse trajectory tracking methods are usually used in a parking system, which mainly adopts an arc-based planning scheme. Such a scheme has a certain requirement for the reference trajectory, which is normally composed of arcs and straight lines. Therefore, the current reverse trajectory tracking methods have a high requirement for the reference trajectory with low flexibility and a narrow range of applications.

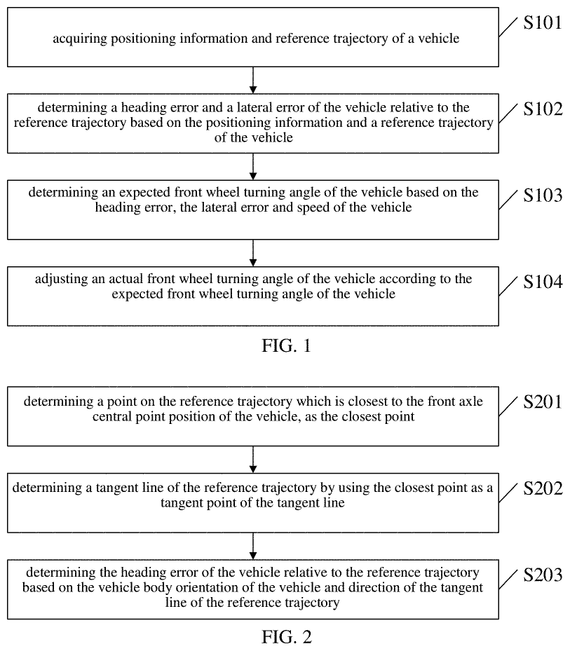

An embodiment of the present application provides a reverse trajectory tracking method. FIG. 1 is a flow chart of implementing a reverse trajectory tracking method according to an embodiment of the present application, which may include the following steps:

S101, acquiring positioning information and a reference trajectory (or reference path) of a vehicle;
S102, determining a heading error and a lateral error of the vehicle relative to the reference trajectory, based on the positioning information and the reference trajectory of the vehicle;
S103, determining an expected front wheel turning angle of the vehicle, based on the heading error, the lateral error and a speed of the vehicle; and
S104, adjusting an actual front wheel turning angle of the vehicle according to the expected front wheel turning angle of the vehicle.

The reverse trajectory tracking method according to the embodiment of the present application may be applied to an autonomous vehicle, and also to a non-autonomous vehicle.

Optionally, the above positioning information of the vehicle may include such information as position (for example, the front axle central point position of the vehicle, the rear axle central point position of the vehicle, and/or a geometric central point position of the vehicle), vehicle-body orientation, speed, and the like, of the vehicle.

In some embodiments, as shown in FIG. 2, the determining the heading error of the vehicle relative to the reference trajectory in S102 includes:

S201, determining a point on the reference trajectory which is closest to the front axle central point position of the vehicle is determined, as the closest point;
S202, determining a tangent line of the reference trajectory by using the closest point as a tangent point;
S203, determining the heading error of the vehicle relative to the reference trajectory based on the vehicle body orientation of the vehicle and the direction of the tangent line of the reference trajectory.

In some embodiments, the determining the lateral error of the vehicle relative to the reference trajectory in S102 may include: determining the shortest distance between the front axle central point position of the vehicle and the reference trajectory, and using the shortest distance as the lateral error of the vehicle relative to the reference trajectory.

In some embodiments, in S103, the expected front wheel turning angle of the vehicle may be determined using the following equation (1):

$$β = {θ}_{e} + {tan}^{- 1} ( \frac{k * c t e}{v} ) ; \qquad ( 1 )$$

where, β is the expected front wheel turning angle of the vehicle;
θₑ is the heading error;
cte is the lateral error;
v is the speed of the vehicle, which is a scalar; and
k is a preset coefficient, which is used to guarantee the calculation accuracy.

In an actual angle determination process, the model of the vehicle may be simplified as a bicycle model. Accordingly, related data may be determined both in S102 and S103 by using the bicycle model. The bicycle model is a simplified controlled object, and the model of the vehicle may be simplified as the bicycle model when the vehicle is travelling at a low speed. Assuming that the vehicle has a structure like a bicycle, that is to say, two front wheels of the vehicle have an identical angel and rotating speed etc., and two rear wheels of the vehicle also have an identical angel and rotating speed etc., the two front wheels and the two rear wheels may be represented as one tire, respectively, and thereby a bicycle model is formed. Front wheel of the bicycle model is located at the central position of the two front wheels of the vehicle, i.e., the front axle central point of the vehicle; rear wheel of the bicycle model is located at the central position of the two rear wheels of the vehicle, i.e., the rear axle central point of the vehicle.

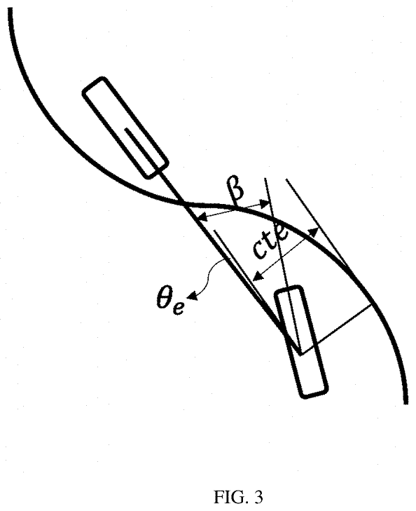

An illustrative implementation to determine the expected front wheel turning angle using the bicycle model will be described with reference to FIG. 3 below. FIG. 3 illustratively shows positions of a bicycle model and a reference trajectory in a reverse trajectory tracking method according to an embodiment of the present application.

As shown in FIG. 3, two long, narrow rectangles and a connection line between the two rectangles constitute the bicycle model, where the rectangle with two of its edges being positioned along the same direction as that of the connection line is the rear wheel of the bicycle model and the rectangle with no edges being positioned along the same direction as that of the connection line is the front wheel of the bicycle model. It can be found that, the direction of the connection line is consistent with the vehicle body orientation of the vehicle. In the embodiment of the present application, the angle between the front wheel of the bicycle model and the connection line may be determined (β in FIG. 3), and the angle may be used as the expected front wheel turning angle of the vehicle. The irregular curve shown in FIG. 3 may be the reference trajectory.

In the illustrative implementation, input information may include the positioning information and the reference trajectory of the vehicle, and output information may include the expected front wheel turning angle of the vehicle, i.e., β in FIG. 3 and the equation (1) above.

As shown in FIG. 3 and the above equation (1), β consists of θₑ and another angle, where θₑ may be a heading error of the vehicle relative to the reference trajectory, i.e., the angle between the vehicle body orientation and a direction of a tangent line of the reference trajectory, and the tangent point of the tangent line is such a point on the reference trajectory, which is closest to the front axle central point of the vehicle (namely, the central point of the front wheel of the bicycle model).

With reference to the above equation (1), the another angle composing a portion of β may be expressed as

$${tan}^{- 1} ( \frac{k * c t e}{v} ) ,$$

where cte may be the lateral error of the vehicle relative to the reference trajectory, i.e., the shortest distance between the front axle central point position of the vehicle and the reference trajectory; v may be current speed of the vehicle; and k may be a preset coefficient.

The expected front wheel turning angle of the vehicle may be determined by calculation of the above equation (1) using the positioning information and the reference trajectory of the vehicle. In some implementations, in the trajectory tracking process according to embodiments of the present application, new positioning information of the vehicle may be acquired constantly as the positioning information of the vehicle changes; the expected front wheel turning angle of the vehicle may be recalculated according to new positioning information of the vehicle and the corresponding reference trajectory; and the actual front wheel turning angle of the vehicle may be adjusted in real time according to the expected front wheel turning angle of the vehicle, thereby realizing the effects such as accurate trajectory tracking.

The reverse trajectory tracking method according to embodiments of the present application may be applied to a technical field of parking, and may also be applied to other scenarios such as reversing vehicle, for example, such a reversing vehicle scenario where a vehicle is reversing when passing through a narrow road. In embodiments of the present application, there is no specific requirement for shape of a reference trajectory, and the reference trajectory may be any curve, any straight line or any combination of curves and straight lines. The computation amount for determining the expected front wheel turning angle of the vehicle is relatively low. Therefore, compared with the related art, the reverse trajectory tracking method according to embodiments of the present application are more flexible with much broader application scenarios.

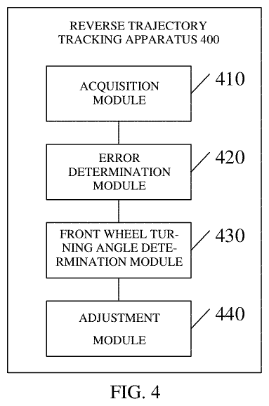

An embodiment of the present application further provides a reverse trajectory tracking apparatus. FIG. 4 is a structural schematic diagram of a reverse trajectory tracking apparatus 400 according to an embodiment of the present application. The reverse trajectory tracking apparatus 400 may include:

an acquisition module 410 configured for acquiring positioning information and reference trajectory of a vehicle;
an error determination module 420 configured for determining a heading error and a lateral error of the vehicle relative to the reference trajectory based on the positioning information and the reference trajectory of the vehicle;
a front wheel turning angle determination module 430 configured for determining an expected front wheel turning angle of the vehicle based on the heading error, the lateral error and a speed of the vehicle; and
an adjustment module 440 configured for adjusting an actual front wheel turning angle of the vehicle according to the expected front wheel turning angle of the vehicle.

In some implementations, the positioning information of the vehicle may include a front axle central point position and a vehicle body orientation of the vehicle.

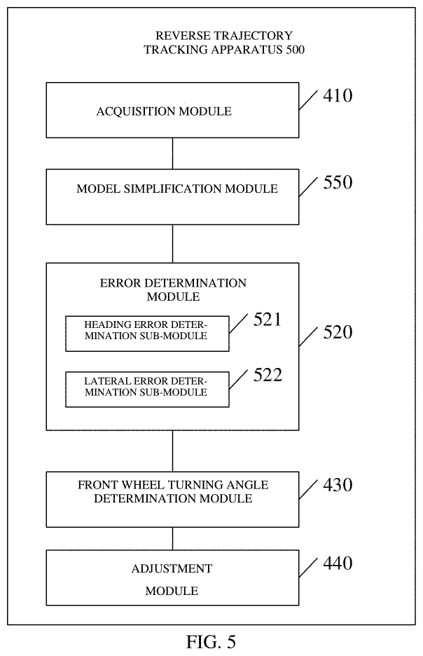

FIG. 5 is a structural schematic diagram of a reverse trajectory tracking apparatus 500 according to an embodiment of the present application. The reverse trajectory tracking apparatus 500 may include an acquisition module 410, an error determination module 520, a front wheel turning angle determination module 430 and an adjustment module 440. Wherein, the error determination module 520 may include:

a heading error determination sub-module 521 configured for determining a point on the reference trajectory which is closest to the front axle central point position of the vehicle, as the closest point; determining a tangent line of the reference trajectory by using the closest point as the tangent point; and determining the heading error of the vehicle relative to the reference trajectory based on the vehicle body orientation of the vehicle and the direction of the tangent line of the reference trajectory.

In some implementations, the positioning information of the vehicle may include a front axle central point position of the vehicle.

As shown in FIG. 5, the error determination module 520 may include:

a lateral error determination sub-module 522 configured for determining a shortest distance between the front axle central point position of the vehicle and the reference trajectory, and using the shortest distance as the lateral error of the vehicle relative to the reference trajectory.

In some embodiments, the front wheel turning angle determination module 430 may be configured to use the following equation to determine the expected front wheel turning angle of the vehicle:

$$β = {θ}_{e} + {tan}^{- 1} ( \frac{k * c t e}{v} ) ;$$

where, β is the expected front wheel turning angle of the vehicle;
θₑ is the heading error;
cte is the lateral error;
v is the speed of the vehicle;
k is a preset coefficient.

As shown in FIG. 5, the apparatus mentioned above may further include a model simplification module 550 configured for determining a bicycle model of the vehicle based on the positioning information of the vehicle.

Wherein, the above error determination module 520 and the front wheel turning angle determination module 430 use the bicycle model to perform the determination.

The function of each module in each of the apparatuses according to embodiments of the present application may refer to corresponding descriptions in the above method, which will not be repeated here.

According to embodiments of the present application, an electronic device and a readable storage medium are also provided herein.

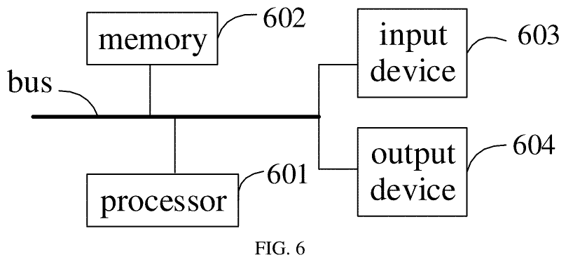

As shown in FIG. 6, it is a block diagram of an electronic device for implementing a reverse trajectory tracking method according to an embodiment of the present application. The electronic device is intended to represent various forms of digital computers, such as laptop computers, desktop computers, workbenches, personal digital assistants, servers, blade servers, mainframe computers, and other suitable computers. Electronic apparatuses may also represent various forms of mobile devices, such as personal digital assistants, cellular phones, smart phones, wearable devices, and other similar computing devices. The components shown herein, their connections and relationships, and their functions are merely examples, and are not intended to limit the implementation of the present application described and/or claimed herein.

As shown in FIG. 6, the electronic device may include: one or more processors 601, a memory 602, and interfaces for connecting various components which include a high-speed interface and a low-speed interface. The various components are connected to each other using different buses and may be installed on a common motherboard or installed in other ways as needed. The processor may process instructions executed within the electronic device, including instructions which are stored in the memory or on the memory to display graphic information of a graphical user interface (GUI) on an external input/output device (such as a display device coupled to the interface). In other embodiments, multiple processors and/or multiple buses may be used with multiple memories if desired. Similarly, multiple electronic devices may be connected, and each device provides a part of necessary operations (for example, as a server array, a group of blade servers, or a multi-processor system). In FIG. 6, one processor 601 is taken as an example.

The memory 602 may be a non-transitory computer readable storage medium provided by the present application. The memory stores instructions executable by at least one processor, so that the at least one processor executes the reverse trajectory tracking method provided by the present application. The non-transitory computer readable storage medium of the present application stores computer instructions, which are used to cause the computer to perform the reverse trajectory tracking method provided by the present application.

The memory 602, as a non-transitory computer readable storage medium, may be used to store non-transitory software programs, non-transitory computer executable programs and modules, such as program instructions/modules (for example, the acquisition module 410, the error determination module 420, the front wheel turning angle determination module 430 and the adjustment module 440 shown in FIG. 4) corresponding to the reverse trajectory tracking method in embodiments of the present application. The processor 601 executes various functional applications and data processing of the server by executing the non-transitory software programs, instructions, and modules stored in the memory 602, that is, implements the reverse trajectory tracking method in foregoing method embodiments.

The memory 602 may include a storage program area and a storage data area, where the storage program area may store an operating system and application programs required by at least one function, and the storage data area may store the data created based on the use of the electronic device for reverse trajectory tracking, etc. In addition, the memory 602 may include a high-speed random access memory, and may also include a non-transitory memory, such as at least one magnetic disk storage device, a flash memory device, or other non-transitory solid-state storage devices. In some embodiments, the memory 602 may optionally include memories set remotely relative to the processor 601, and these remote memories may be connected to the electronic device for reverse trajectory tracking through a network. Instances of the above network include but are not limited to the Internet, an intranet, a local area network, a mobile communication network, and combinations thereof.

The electronic device for reverse trajectory tracking may further include: an input device 603 and an output device 604. The processor 601, the memory 602, the input device 603 and the output device 604 may be connected through a bus or in other ways. In FIG. 6, the connection through a bus is taken as an example.

The input device 603, such as a touch screen, a keypad, a mouse, a trackpad, a touchpad, an indication rod, one or more mouse buttons, a trackball, a joystick, etc. may receive input numeric or character information, and generate key signal inputs related to user settings and function control of the electronic device for reverse trajectory tracking. The output device 604 may include a display apparatus, an auxiliary lighting device (for example, LED), a tactile feedback device (for example, a vibration motor), and the like. The display apparatus may include, but is not limited to, a liquid crystal display (LCD), a light emitting diode (LED) display, and a plasma display. In some embodiments, the display apparatus may be a touch screen.

Various embodiments of the systems and techniques described herein may be implemented in digital electronic circuit systems, integrated circuit systems, application specific integrated circuits (ASICs), computer hardware, firmware, software, and/or combination thereof. These various embodiments may include: implementations in one or more computer programs which may be executed and/or interpreted on a programmable system that includes at least one programmable processor, which may be a dedicated or general-purpose programmable processor that may receive data and instructions from a storage system, at least one input device, and at least one output device, and transmit the data and instructions to the storage system, the at least one input device, and the at least one output device.

These computer programs (also called as programs, software, software applications, or codes) include machine instructions of programmable processors, and these computer programs may be implemented using a high-level process and/or object-oriented programming language, and/or an assembly/machine language. As used herein, the terms “machine readable medium” and “computer readable medium” refer to any computer program product, apparatus, and/or device (for example, a magnetic disk, an optical disk, a memory, a programmable logic device (PLD)) used to provide machine instructions and/or data to a programmable processor, including the machine readable medium that receives machine instructions as machine readable signals. The term “machine readable signal” refers to any signal used to provide machine instructions and/or data to the programmable processor.

In order to provide interactions with a user, the system and technology described herein may be implemented on a computer which has: a display device (for example, CRT (Cathode Ray Tube) or LCD (liquid crystal display) monitor) for displaying information to the user; and a keyboard and pointing device (for example, a mouse or a trackball) through which the user may provide input to the computer. Other kinds of devices may also be used to provide interactions with a user; for example, the feedback provided to a user may be any form of sensory feedback (for example, visual feedback, auditory feedback, or tactile feedback); and input from a user may be received using any form (including acoustic input, audio signal input, or tactile input).

The systems and techniques described herein may be implemented in a computing system (for example, as a data server) that includes back-end components, or a computing system (for example, an application server) that includes middleware components, or a computing system (for example, a user computer with a graphical user interface or a web browser through which the user may interact with the implementation of the systems and technologies described herein) that includes front-end components, or a computing system that includes any combination of such back-end components, intermediate components, or front-end components. The components of the system may be interconnected by any form or medium of digital data communication (for example, a communication network). Examples of communication networks include: a Local Area Network (LAN), a Wide Area Network (WAN), and the Internet.

The computer system may include a client and a server. The client and the server are generally remote from each other and typically interact through a communication network. The client-server relationship is generated by computer programs that run on respective computers and have a client-server relationship with each other. The server may be a cloud server, also referred to as could computing server or cloud host, which is a kind of host product in a cloud computing service architecture for dealing with the defects existing in services of traditional physical hosts and virtual private servers (VPS), such as severe difficulty on management and weak extendibility on services.

It should be understood that various forms of processes shown above may be used to reorder, add, or delete steps. For example, respective steps described in the present application may be executed in parallel, or may be executed sequentially, or may be executed in a different order, as long as the desired result of the technical solution disclosed in the present application can be achieved, no limitation is made herein.

The above specific embodiments do not constitute a limitation on the protection scope of the present application. It should be understood by those skilled in the art that various modifications, combinations, sub-combinations, and substitutions may be made according to design requirements and other factors. Any modification, equivalent replacement and improvement, and the like made within the spirit and principle of the present application shall fall within the protection scope of the present application.

What is claimed is:

1. A reverse trajectory tracking method, comprising:
acquiring positioning information and a reference trajectory of a vehicle;
determining a heading error and a lateral error of the vehicle relative to the reference trajectory, based on the positioning information and the reference trajectory of the vehicle;
determining an expected front wheel turning angle of the vehicle, based on the heading error, the lateral error and a speed of the vehicle; and
adjusting an actual front wheel turning angle of the vehicle according to the expected front wheel turning angle of the vehicle.

2. The method according to claim 1, wherein the positioning information of the vehicle comprises a front axle central point position and a vehicle body orientation of the vehicle;
the determining the heading error of the vehicle relative to the reference trajectory, based on the positioning information and the reference trajectory of the vehicle, comprises:
determining a point on the reference trajectory which is closest to the front axle central point position of the vehicle, as the closest point;
determining a tangent line of the reference trajectory by using the closest point as a tangent point of the tangent line; and
determining the heading error of the vehicle relative to the reference trajectory based on the vehicle body orientation of the vehicle and a direction of the tangent line of the reference trajectory.

3. The method according to claim 1, wherein the positioning information of the vehicle comprises a front axle central point position of the vehicle;
the determining the lateral error of the vehicle relative to the reference trajectory, based on the positioning information and the reference trajectory of the vehicle, comprises:
determining a shortest distance between the front axle central point position of the vehicle and the reference trajectory, and using the shortest distance as the lateral error of the vehicle relative to the reference trajectory.

4. The method according to claim 1, wherein the determining the expected front wheel turning angle of the vehicle, based on the heading error, the lateral error and the speed of the vehicle, comprises:
determining the expected front wheel turning angle of the vehicle by using a following equation:
$$β = {θ}_{e} + {tan}^{- 1} ( \frac{k * c t e}{v} ) ;$$
where, β is the expected front wheel turning angle of the vehicle;
θₑ is the heading error;
cte is the lateral error;
v is the speed of the vehicle; and
k is a preset coefficient.

5. The method according to claim 2, wherein the determining the expected front wheel turning angle of the vehicle, based on the heading error, the lateral error and the speed of the vehicle, comprises:
determining the expected front wheel turning angle of the vehicle by using a following equation:
$$β = {θ}_{e} + {tan}^{- 1} ( \frac{k * c t e}{v} ) ;$$
where, β is the expected front wheel turning angle of the vehicle;
θₑ is the heading error;
cte is the lateral error;
v is the speed of the vehicle; and
k is a preset coefficient.

6. The method according to claim 3, wherein the determining the expected front wheel turning angle of the vehicle, based on the heading error, the lateral error and the speed of the vehicle, comprises:
determining the expected front wheel turning angle of the vehicle by using a following equation:
$$β = {θ}_{e} + {tan}^{- 1} ( \frac{k * c t e}{v} ) ;$$
where, β is the expected front wheel turning angle of the vehicle;
θₑ is the heading error;
cte is the lateral error;
v is the speed of the vehicle; and
k is a preset coefficient.

7. The method according to claim 1, further comprising: determining a bicycle model of the vehicle, based on the positioning information of the vehicle;
wherein, determining the heading error and the lateral error of the vehicle relative to the reference trajectory and the expected front wheel turning angle of the vehicle comprises:
performing the determining the heading error and the lateral error of the vehicle relative to the reference trajectory and the expected front wheel turning angle of the vehicle, by using the bicycle model of the vehicle and the reference trajectory.

8. The method according to claim 2, further comprising: determining a bicycle model of the vehicle, based on the positioning information of the vehicle;
wherein, determining the heading error and the lateral error of the vehicle relative to the reference trajectory and the expected front wheel turning angle of the vehicle comprises:
performing the determining the heading error and the lateral error of the vehicle relative to the reference trajectory and the expected front wheel turning angle of the vehicle, by using the bicycle model of the vehicle and the reference trajectory.

9. A reverse trajectory tracking apparatus, comprising:
a processor and a memory for storing one or more computer programs executable by the processor,
wherein when executing at least one of the computer programs, the processor is configured to perform operations comprising:
acquiring positioning information and a reference trajectory of a vehicle;
determining a heading error and a lateral error of the vehicle relative to the reference trajectory, based on the positioning information and the reference trajectory of the vehicle;
determining an expected front wheel turning angle of the vehicle based on the heading error, the lateral error and a speed of the vehicle; and
adjusting an actual front wheel turning angle of the vehicle according to the expected front wheel turning angle of the vehicle.

10. The apparatus according to claim 9, wherein the positioning information of the vehicle comprises a front axle central point position and a vehicle body orientation of the vehicle;
wherein when executing at least one of the computer programs, the processor is configured to further perform operations comprising:
determining a point on the reference trajectory which is closest to the front axle central point position of the vehicle, as the closest point; determining a tangent line of the reference trajectory by using the closest point as the a tangent point of the tangent line; and determining the heading error of the vehicle relative to the reference trajectory based on the vehicle body orientation of the vehicle and a direction of the tangent line of the reference trajectory.

11. The apparatus according to claim 9, wherein the positioning information of the vehicle comprises a front axle central point position of the vehicle;
wherein when executing at least one of the computer programs, the processor is configured to further perform operations comprising:
determining a shortest distance between the front axle central point position of the vehicle and the reference trajectory, and using the shortest distance as the lateral error of the vehicle relative to the reference trajectory.

12. The apparatus according to claim 9, wherein when executing at least one of the computer programs, the processor is configured to further perform operations comprising:
determining the expected front wheel turning angle of the vehicle by using a following equation,
$$β = {θ}_{e} + {tan}^{- 1} ( \frac{k * c t e}{v} ) ;$$
where, β is the expected front wheel turning angle of the vehicle;
θₑ is the heading error;
cte is the lateral error;
v is the speed of the vehicle; and
k is a preset coefficient.

13. The apparatus according to claim 10, wherein when executing at least one of the computer programs, the processor is configured to further perform operations comprising:
determining the expected front wheel turning angle of the vehicle by using a following equation,
$$β = {θ}_{e} + {tan}^{- 1} ( \frac{k * c t e}{v} ) ;$$
where, β is the expected front wheel turning angle of the vehicle;
θₑ is the heading error;
cte is the lateral error;
v is the speed of the vehicle; and
k is a preset coefficient.

14. The apparatus according to claim 9, wherein when executing at least one of the computer programs, the processor is configured to further perform operations comprising:
determining a bicycle model of the vehicle based on the positioning information of the vehicle; and
performing the determining the heading error and the lateral error of the vehicle relative to the reference trajectory and the expected front wheel turning angle of the vehicle, by using the bicycle model and the reference trajectory.

15. The apparatus according to claim 10, wherein when executing at least one of the computer programs, the processor is configured to further perform operations comprising:
determining a bicycle model of the vehicle based on the positioning information of the vehicle; and
performing the determining the heading error and the lateral error of the vehicle relative to the reference trajectory and the expected front wheel turning angle of the vehicle, by using the bicycle model and the reference trajectory.

16. A non-transitory computer-readable storage medium storing computer instructions, wherein the computer instructions, when executed by a computer, cause the computer to execute:
acquiring positioning information and a reference trajectory of a vehicle;
determining a heading error and a lateral error of the vehicle relative to the reference trajectory, based on the positioning information and the reference trajectory of the vehicle;
determining an expected front wheel turning angle of the vehicle, based on the heading error, the lateral error and a speed of the vehicle; and
adjusting an actual front wheel turning angle of the vehicle according to the expected front wheel turning angle of the vehicle.

17. The non-transitory computer-readable storage medium according to claim 16,
wherein the positioning information of the vehicle comprises a front axle central point position and a vehicle body orientation of the vehicle; and
wherein the computer instructions, when executed by a computer, cause the computer to further execute:
determining a point on the reference trajectory which is closest to the front axle central point position of the vehicle, as the closest point;
determining a tangent line of the reference trajectory by using the closest point as a tangent point of the tangent line; and
determining the heading error of the vehicle relative to the reference trajectory based on the vehicle body orientation of the vehicle and a direction of the tangent line of the reference trajectory.

18. The non-transitory computer-readable storage medium according to claim 16,
wherein the positioning information of the vehicle comprises a front axle central point position of the vehicle; and
wherein the computer instructions, when executed by a computer, cause the computer to further execute:
determining a shortest distance between the front axle central point position of the vehicle and the reference trajectory, and using the shortest distance as the lateral error of the vehicle relative to the reference trajectory.

19. The non-transitory computer-readable storage medium according to claim 16,
wherein the computer instructions, when executed by a computer, cause the computer to further execute:
determining the expected front wheel turning angle of the vehicle by using a following equation:
$$β = {θ}_{e} + {tan}^{- 1} ( \frac{k * c t e}{v} ) ;$$
where, β is the expected front wheel turning angle of the vehicle;
θₑ is the heading error;
cte is the lateral error;
v is the speed of the vehicle; and
k is a preset coefficient.

20. The non-transitory computer-readable storage medium according to claim 16,
wherein the computer instructions, when executed by a computer, cause the computer to further execute:
determining a bicycle model of the vehicle, based on the positioning information of the vehicle; and
performing the determining the heading error and the lateral error of the vehicle relative to the reference trajectory and the expected front wheel turning angle of the vehicle, by using the bicycle model of the vehicle and the reference trajectory.
